(19) United States
(12) Patent Application Publication
(10) Pub. No.: US 2023/0059724 A1
(43) Pub. Date: Feb. 23, 2023

(54) GALVANIC CORROSION RESISTANT FASTENER

(71) Applicant: GM GLOBAL TECHNOLOGY OPERATIONS LLC, Detroit, MI (US)

(72) Inventors: Pei-chung WANG, Troy, MI (US); Michael A. Kardasz, Troy, MI (US); Mark O. Vann, Canton, MI (US); Steven Cipriano, Chesterfield Township, MI (US); Bradley J. Blaski, Sterling Heights, MI (US); Anthony Bastuk, Grand Blanc, MI (US); Christopher Fenech, Brownstown, MI (US); John Fragnoli, Troy, MI (US)

(21) Appl. No.: 17/408,596

(22) Filed: Aug. 23, 2021

(51) Int. Cl. F16B 33/00; F16B 19/08; F16B 39/282; B62D 27/06

(52) U.S. Cl. CPC F16B 33/008; B62D 27/065; F16B 19/086; F16B 39/282

(57) ABSTRACT

A fastening assembly includes: a panel defining an aperture; a fastener having a cap and a shaft extending from the cap, the shaft being disposed through the aperture, the fastener having a first corrosion rate, and the fastener including: a recess formed in the cap and extending at least partially around the shaft; face surfaces that are planar and that are to directly contact the panel; and recessed channels that are disposed between the face surfaces, respectively, that are recessed relative to the face surfaces, and that extend from a radially outer edge of the cap to the recess; and an anode insert disposed in the recess and having a second corrosion rate that is faster than the first corrosion rate.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to fasteners and more particularly to fasteners configured to resist galvanic corrosion.

Fastener assemblies come in a variety of shapes, sizes, designs and materials. Many fastening assemblies include not only a fastener 114 such as a bolt, pin or screw, but also will include a fastener insert 122 to be positioned within a tapped hole of a substrate or threaded nut barrel 178 as shown in FIGS. 1A-1B. A bracket may also be viewed as a component of a fastening assembling given that a bracket may be used to couple one member to another member.

Steel fasteners have been passivated and coated with zinc chromate in an effort to prevent galvanic corrosion. As is generally known, galvanic corrosion is an electrochemical process between dissimilar metals and alloys having different electrode potentials such that one metal (the anode) corrodes preferentially when it is in electrical contact with a dissimilar metal (the cathode) in the presence of an electrolyte (ex: water and road salt). However, the application of the zinc chromate requires strict quantitative controls and is considered labor intensive. The installation tools for the fasteners may require frequent cleaning to prevent build-up of the zinc chromate on mandrels of the tool which is undesirable. The application of too little zinc chromate leads to certain other problems such as inadequate corrosion protection wherein undesirable galvanic corrosion 111 may develop across the fastener 114 and the threaded nut barrel 178. (See FIGS. 1A-1B). The galvanic corrosion 111 compromises the strength of the fastener assembly ,and causes an unsightly appearance of the overall assembly due to the visibility of the corrosion across the fastener assembly. Other coatings may be formed from a fluoropolymer composition, which is coated onto a steel fastener. However, aside from insufficient protection from galvanic corrosion when coating a fastener 114 (as previously noted), the additional step of applying a coating, sealant or plating to the insert can lead to added expense in the manufacturing process.

Accordingly, there is a need to provide a fastening assembly which provides improved resistance to galvanic corrosion in a cost-effective manner.

### SUMMARY

In a feature, a fastening assembly includes: a panel defining an aperture; a fastener having a cap and a shaft extending from the cap, the shaft being disposed through the aperture, the fastener having a first corrosion rate, and the fastener including: a recess formed in the cap and extending at least partially around the shaft; face surfaces that are planar and that are to directly contact the panel; and recessed channels that are disposed between the face surfaces, respectively, that are recessed relative to the face surfaces, and that extend from a radially outer edge of the cap to the recess; and an anode insert disposed in the recess and having a second corrosion rate that is faster than the first corrosion rate.

In further features, the panel includes carbon fiber.

In further features, the fastener is made of steel.

In further features, the anode insert is made of aluminum.

In further features, the recess is an annular recess that encircles the shaft.

In further features, the panel has a third corrosion rate, and the second corrosion rate is faster than the third corrosion rate.

In further features, the recessed channels extend radially outwardly from the recess to the radially outer edge of the cap.

In further features, a retention component is configured to engage an engagement feature of the fastener.

In further features, the fastener is a mandrel and the retention component is a sleeve.

In further features, the sleeve includes a recess and a second anode insert disposed in the recess.

In further features, the fastener is a bolt having a threaded shaft and the retention component is a nut threaded onto the threaded shaft.

In further features, the nut includes a recess and a second anode insert disposed in the recess.

In further features, the fastener is one of a rivet and a flow screw.

In further features, the fastener has a higher electrode potential than the anode insert.

In further features, a depth of the recessed channels is between 0.5 millimeters and one-half of a thickness of the cap.

In further features, the recessed channels are half cylindrical.

In further features, the recessed channels are disposed equidistantly from each other radially around the shaft.

In a feature, a truck includes: a truck bed; a truck bed liner including the panel; and the fastening assembly fastening the truck bed liner to the truck bed.

In a feature, a fastening assembly includes: a fastener having a cap and a shaft extending from the cap, the fastener having a first corrosion rate, and the fastener including: a recess formed in the cap and extending at least partially around the shaft; face surfaces that are planar; and recessed channels that are disposed between the face surfaces, respectively, that are recessed relative to the face surfaces, and that extend from a radially outer edge of the cap to the recess; and an anode insert disposed in the recess and having a second corrosion rate that is faster than the first corrosion rate.

In a feature, a fastening assembly includes: a fastener having a cap and a shaft extending from the cap, the fastener having a first electrode potential, and the fastener including: one or more recesses formed in the fastener; outer surfaces; and recessed channels that are recessed relative to the outer surfaces, and that extend from an outer edge of the fastener to the one or more recesses; and one or more anode inserts disposed in the one or more recesses and having a second electrode potential that is less than the first electrode potential.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1A is a top view of a plurality of fasteners used to secure a carbon fiber reinforced polymeric panel;

FIG. 1B is a bottom view of the plurality of fasteners in FIG. 1A used to secure the carbon fiber reinforced polymeric panel;

FIG. 2A is a cross-sectional view of an example fastener;

FIG. 2B is a top view of the anode inserts used in FIG. 2A;

FIG. 3A is a cross sectional view of an example fastener prior to installation onto a panel;

FIG. 3B is a cross-sectional view of the example in FIG. 3A when the fastener is fully installed;

FIG. 4 is a cross-sectional view of an example fastener;

FIG. 5A a cross-sectional view of an example fastener;

FIG. 5B is a cross-sectional view of an example fastener;

FIG. 5C is a cross-sectional view of the fastener assembly using a rivet where the anode insert is forged into the distal end of the rivet;

FIG. 6A is a cross-sectional view of an example fastener where the anode insert is partially exposed;

FIG. 6B is a top view of the fastening assembly in FIG. 6A;

FIG. 7 includes a perspective view of an example implementation of a fastener of a fastening assembly with channels;

FIG. 8 is a cross-sectional view of a channel;

FIG. 9 includes a perspective view including an example implementation of a bolt and a collar/nut, where the bolt and the collar/nut includes the channels;

FIG. 10 includes a perspective view of an example implementation of a fastener of a fastening assembly with channels; and

FIG. 11 includes a perspective view of an example implementation of a fastener of a fastening assembly with channels.

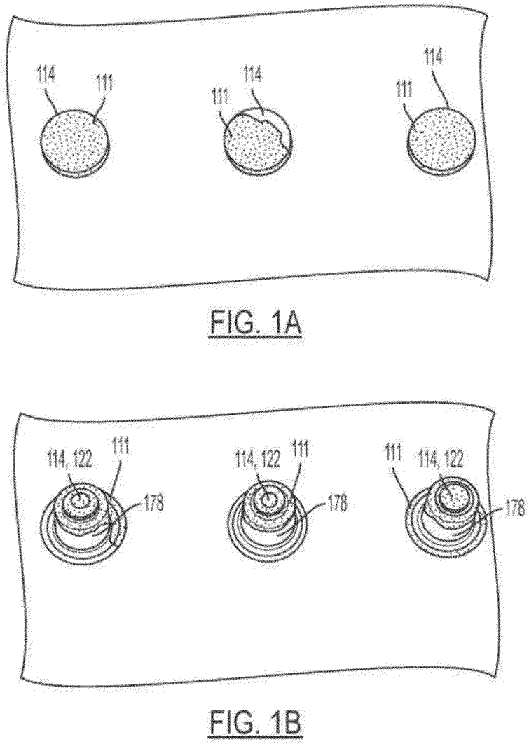

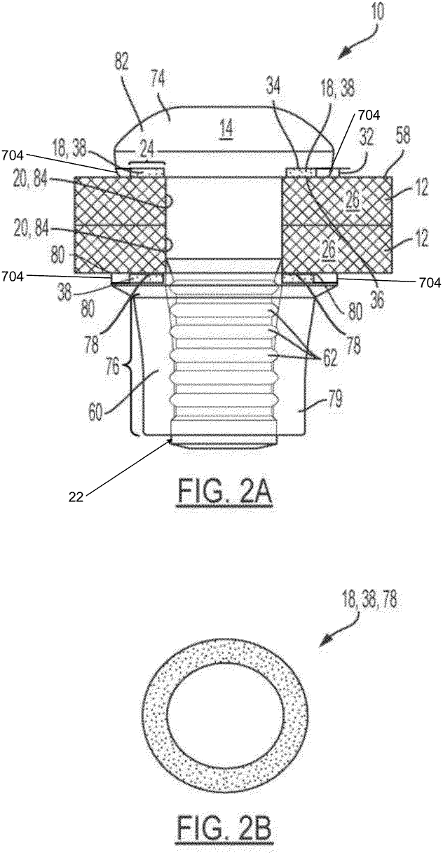

In the drawings, reference numbers may be reused to identify similar and/or identical elements.

### DETAILED DESCRIPTION

Fasteners are used to fasten various items together. For example, a pickup truck may include a truck bed box and a truck bed liner. Fasteners (e.g., bolts and nuts) can be used to fasten the truck bed liner to the truck bed box.

Different types of materials, however, have different electrode potentials and therefore different corrosion rates. For example, truck bed liners including carbon fiber composites may corrode more slowly than the fasteners used to fasten the truck bed liner to the truck bed box (e.g., metal).

The present application involves a fastener with a sacrificial anode insert disposed in a recess around a shaft of the fastener. The anode insert has a faster corrosion rate than the fastener to focus corrosion on the anode insert and not the fastener. The surface of a head of the fastener that is configured to contact the truck bed also includes channels formed from the recess to a radially outer edge of the head. The channels enable electrolyte (e.g., air, water, etc.) flow to the anode insert, increasing corrosion of the anode insert and decreasing corrosion of the fastener.

Referring now to FIGS. 2A-6B, the present application provides a fastening assembly 10 which may include a plurality of panels 12, a fastener 14 and a primary anode insert 18. The fastener 14 (non-limiting examples shown in FIGS. 2A-6B) has a higher electrode potential than the anode insert 18. The fastener 14 may be provided in a variety of forms, such as but not limited to a rivet, a flow screw, a bracket, a stud, a bolt, etc. As noted, a bracket may also be viewed as a component of a fastening assembling given that a bracket may be used to couple one member to another member in a variety of forms, such as but not limited to a rivet, a flow screw, a bracket, a stud, a bolt, a nut, washer, etc.

The anode insert 18 has a first corrosion rate, and the fastener 14 has a second corrosion rate that is slower than the first corrosion rate. Corrosion rates may refer to rates at which the respective components experience corrosion (or corrode). The panel(s) 12 have a third corrosion rate that is slower than the second corrosion rate. In this manner, the anode insert 18 corrodes faster than the fastener 14 and the panel(s) 12.

Each panel 12 may be formed from material with high potential (e.g., a carbon fiber thermoplastic composite) 26 which is resistant to corrosion and has the third corrosion rate. In this circumstance, galvanic corrosion at the fastening assembly 10 (specifically the anode insert 18) may be accelerated given that panel(s) 12 made from carbon fiber thermoplastic 26 or magnesium and are very resistant to corrosion. Given the potential and corrosion rate of the anode insert 18, however, the corrosion will be more concentrated to the anode insert 18 and less concentrated to the panel(s) 12 and the fastener 14.

Each panel 12 defines an aperture 20 and the fastener 14 includes a shaft portion 22 disposed within the aperture 20. The anode insert 18 may be disposed adjacent to a reaction region 24 of the fastener 14 and encircle the shaft portion 22. The fastener 14 may be formed from metal (e.g., steel, stainless steel, etc.) or another type of electrically conductive material. Moreover, the anode insert 18 may define an insert thickness 32 between an upper surface 34 and a lower surface 36.

The anode insert 18 may sit within an annular recess formed in the shoulder portion of the fastener 14. As shown in FIGS. 2A-5A, the anode insert 18 may be completely embedded under the cap/flange of the fastener (or sleeve flange) so that the cosmetic appearance of the overall fastening assembly will not be detracted by the sacrificial corroding anode insert 18.

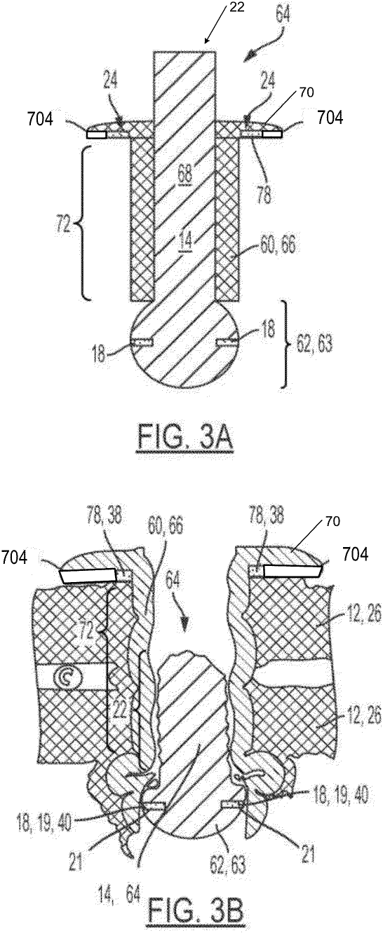

The aforementioned fastener 14 may, but not necessarily be a rivet 42 or a flow screw 44. In one non-limiting example, the anode insert 18 may be a washer 38, such as a standard washer or a spring washer. In another non-limiting example, the anode insert 18 may be an elongated member 40 such as a pin 19 (e.g., see FIG. 3B) which may be press-fit into the fastener 14 (shown as a mandrel 64 in FIG. 3B). Regardless of the configuration of the anode insert 18, the amount (weight) of the anode insert 18 would depend on the contact area between the metal fastener and cathode (e.g., carbon fiber composite). The anode insert 18 should have sufficient material such that it would last for the lifetime of the fastener (e.g., 15 years for automotive application). The anode insert 18 may be, for example, made of aluminum or another suitable material that has a higher potential than the fastener 14 and that corrodes faster than the fastener 14.

With reference to FIGS. 2A-3B, the fastening assembly 10 may optionally further comprise a retention component (a retainer) 60 which engages with an engagement feature 62 of the fastener 14 (e.g., formed on an outer surface of the fastener 14). In the non-limiting examples shown in FIGS. 3A-3B having the additional retention component 60, the fastener 14 may optionally be a mandrel 64 and the retention component 60 may be a sleeve 66 where the mandrel 64 deforms the sleeve 66 to form the fastening assembly 10. The mandrel 64 may define a shaft 68 integral to a head 63 having an anode insert affixed to the head 63, and the sleeve 66 may define a sleeve flange 70 and a cylindrical body 72. FIG. 3A is an illustration before fastening, and FIG. 3B is an illustration after fastening.

The anode insert 18 may be affixed to the head 63 in various ways. In one example, the anode insert 18 may be a pin 19 which is inserted into an aperture 21 defined in the head 63 (see FIG. 3B). In another non-limiting example, the anode insert 18 may be press-fitted into a groove/cavity/aperture 21 defined in the head 63. In this example, the fastening assembly 10 may further include a second anode insert 78 disposed between the sleeve flange 70 and each panel 12 as shown in FIGS. 3A-3B.

With reference back to FIGS. 2A-2B, another example having the additional retention component 60 is shown wherein the fastener 14 is provided in the form of a bolt 74. The bolt 74 includes a threaded shaft 76, and the retention component 60 may be a threaded nut (or collar) 79 which is swaged or screwed onto the bolt’s threaded shaft 76. In the aforementioned non-limiting example, the second anode insert 78 may be integrated into the retention component 60 (nut/collar 79 in FIG. 2A) such that the anode insert 78 is adjacent to a lower surface 80 of the plurality of panels 12, and the anode insert 18 is integrated into the cap/flange 82 of the bolt 74 such that the anode insert 18 is adjacent to the upper surface 58 of the plurality of panels 12.

The anode insert 18 in FIGS. 2A-2B is configured to preferentially undergo galvanic corrosion while the fastener 14 in the form of the bolt 74 and nut 79 experiences inhibited and less corrosion. Accordingly, the strength of the fastening assembly 10 is not compromised despite the galvanic corrosion which is concentrated at the anode insert 18 and the second anode insert 78 because the corroded anode insert(s) 18, 78 are not located in a high stress region (at the stress raiser).

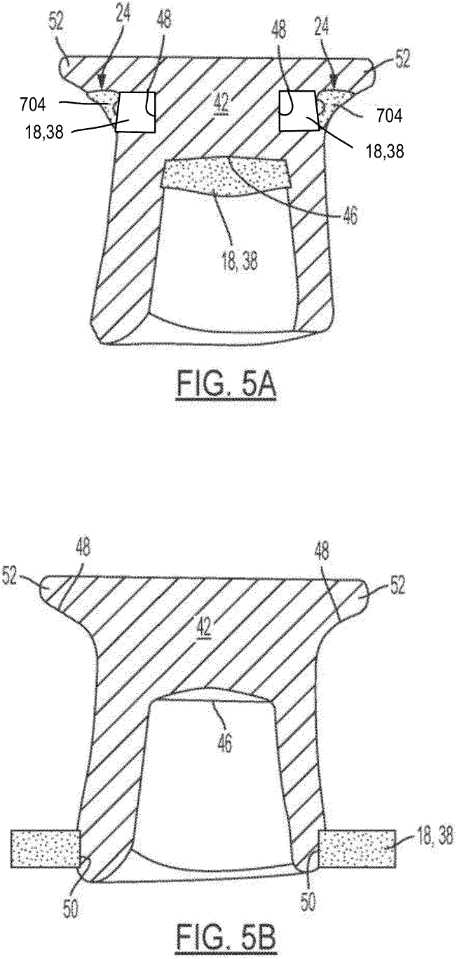

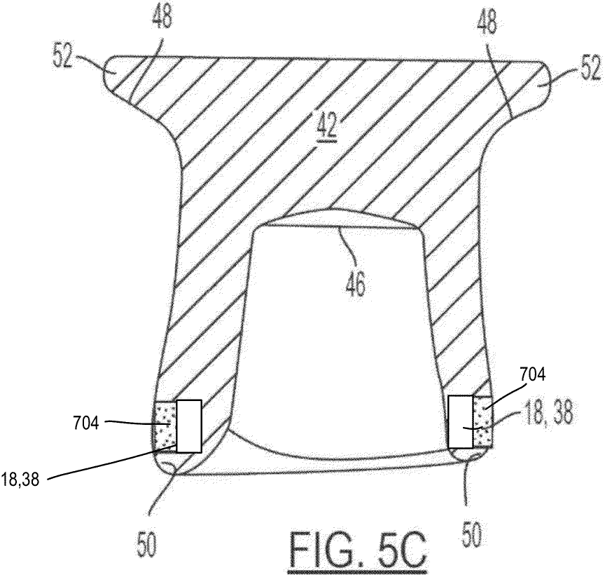

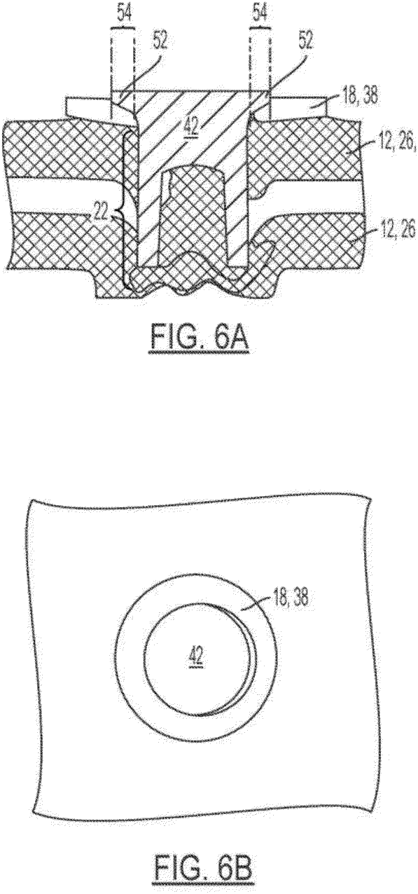

With reference to FIGS. 5A-6B, the fastener 14 may be provided in the form of a rivet 42 wherein the anode insert 18 may be disposed adjacent to at least one of an interior ceiling 46 surface of the rivet 42 (see FIG. 5A), a flange curve 48 of the rivet 42 (see FIG. 5A), and a distal end 50 of the rivet 42 (see FIGS. 5B-5C). As shown in FIG. 5A, the rivet 42 may further define a flange 52 which may cover the anode insert 18 and secure the anode insert 18 against each panel 12. However, it is also understood that the flange 52 may alternatively only cover a portion 54 of the primary anode insert 18, such as shown in FIGS. 6A-6B.

The anode insert 18 in FIGS. 5A-6B is configured to undergo galvanic corrosion while the fastener 14 in the form of the rivet 42 experiences inhibited or less corrosion. Accordingly, the strength of the fastening assembly 10 is not compromised despite the galvanic corrosion, which is concentrated at the primary anode insert 18 because the anode insert 18 is not located at the stress raiser. Moreover, given that the insert 18 is hidden under the flange 52, the cosmetic appearance of the fastening assembly 10 is not compromised as the anode insert 18 undergoes (sacrificial) galvanic corrosion.

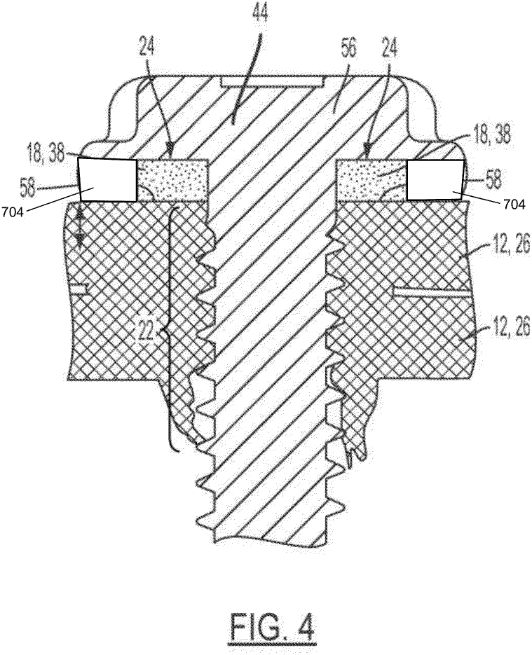

In yet another example, the fastening assembly 10 may simply include a fastener 14 and a primary anode insert 18 as shown in FIGS. 2A-6B. As shown in the aforementioned figures, the fastener 14 includes a shaft portion 22, which is configured to be disposed within at least two aligned component apertures 84. As shown, each anode insert 18 may be also be disposed adjacent to a reaction region 24 of the fastener 14. The anode insert 18 may define an insert thickness 32 between an upper surface 34 and a lower surface 36. With reference to FIGS. 4-6B, the fastener 14 may, but not necessarily, be one of a rivet 42 (see FIGS. 5A-6B) or a flow screw 44 (see FIG. 4). However, as shown in FIGS. 2A-3B, it is understood that the fastener 14 assembly may further comprise a retention component 60 wherein the fastener 14 may, but not necessarily be a bolt 74 having a threaded shaft 76 or a mandrel 64. As shown in FIGS. 2A-3B, the retention component 60 is configured to engage with an engagement feature 62 in the fastener 14. With reference to FIGS. 3A-3B, the fastener 14 is provided in the form of a mandrel 64, and the retention component 60 is provided in the form of a sleeve 66. Sleeve 66 is configured to deform (see FIG. 3B) when mandrel 64 engages with the sleeve 66.

As shown in FIGS. 2A-2B, where the fastener 14 is provided in the form of a bolt 74, the retention component 60 may be provided in the form of a nut 79, which is swaged/threaded onto the threaded shaft 76 of the bolt 74. It is understood that second anode inserts 78 may be implemented as part of the fastener 14 assembly when a retention component 60 is used as part of the assembly as shown in FIGS. 2A-3B. Accordingly, the anode insert(s) 18 in FIGS. 5A-6B is configured to preferentially undergo galvanic corrosion while the fastener 14 (the secondary anode metal/alloy) in the form of the rivet 42 experiences inhibited/less/slower corrosion. Accordingly, the strength of the fastening assembly 10 is not compromised despite the galvanic corrosion, which is concentrated at the anode insert 18.

Referring now to FIG. 4, the fastener 14 may be provided in the form of a flow screw 44 wherein the flow screw 44 includes a cap 56 which may completely cover the primary anode insert 18 and secure the anode insert 18 against an upper surface 58 of the plurality of panels 12. Similarly, the anode insert 18 in FIG. 4 is configured to preferentially undergo galvanic corrosion while the fastener 14 in the form of the flow screw 44 experiences inhibited corrosion. Accordingly, the strength of the fastening assembly 10 is not compromised despite the galvanic corrosion, which is concentrated at the anode insert 18. Moreover, the cap 56 of the flow screw 44 obscures the view of anode insert 18 as it undergoes galvanic corrosion.

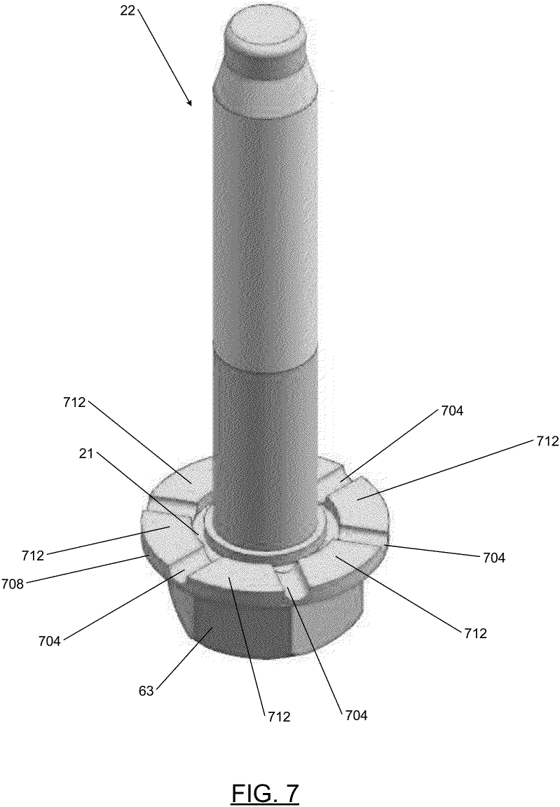

FIG. 7 includes a perspective view of an example implementation of a fastener of the fastening assembly. As described above, the fastener 14 includes the shaft portion 22 (e.g., threaded or non-threaded) and a cap/flange 82. The annular recess 21 is formed in the surface of the cap/flange 82 that directly contacts one of the panels 12.

As illustrated in FIG. 7, channels 704 are formed in the cap/flange 82 and extend from a radially outer edge 708 of the cap/flange to the anode insert 18 and the annular recess 21. This allows electrolyte (e.g., air, water, etc.) to flow through the channels to the anode insert 18 to facilitate corrosion of the anode insert 18 and to decrease corrosion of the fastener 14. In various implementations, the panels 12 may be carbon fiber including panels of a truck bed, and the fastener assembly 10 may be used to fasten the truck bed to a chassis of the truck.

The channels 704 extend perpendicularly to an axis of the shaft portion 22 and radially outwardly from the axis. The channels 704 may be spaced equidistantly radially relative to the axis. For example, 6 of the channels 704 spaced 60 degrees apart (e.g., center to center) from each other is illustrated. While the example of 6 (six) channels is illustrated, the present application is applicable to 2 or more channels.

The channels 704 are areas that are recessed relative to faces 712 that directly contact the panel 12. The channels 704 may be half-cylindrical or have another suitable cross-sectional shape, such as rectangular or triangular.

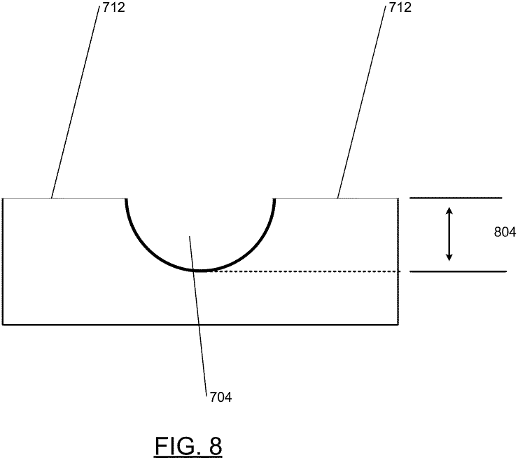

FIG. 8 is a cross-sectional view of a channel. The channels 704 are recessed a distance 804 relative to the faces 712. In various implementations, the distance 804 may be between 0.5 millimeters (mm) and one half of a total height of the cap/flange 82. Distances within this range may maximize corrosion of the anode insert 18 and minimize corrosion of the fastener 14.

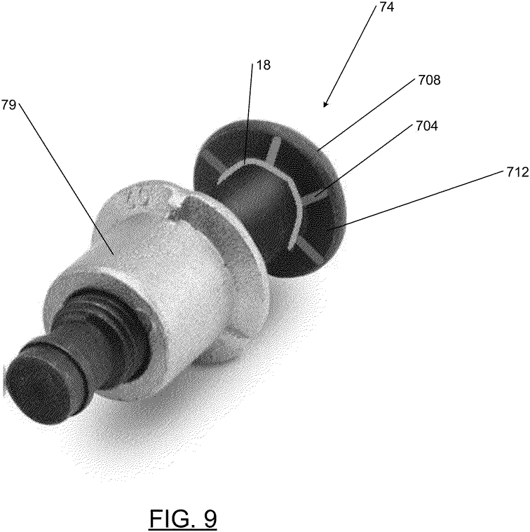

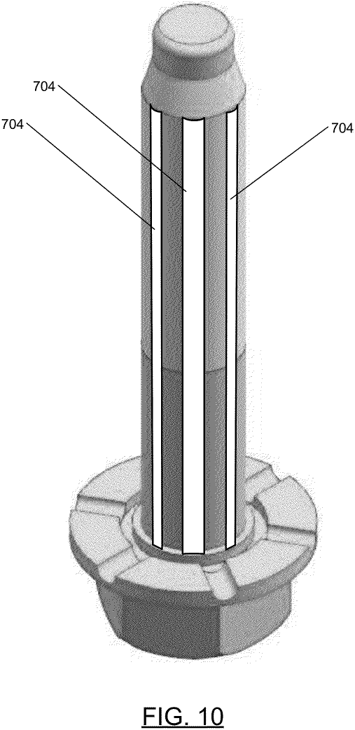

FIG. 9 includes a perspective view including an example implementation of the bolt 74 and the collar/nut 79, where the bolt 74 includes the channels 704 formed in the surface of the cap/flange 82 that contacts one of the panels 12. The collar/nut 79 may also include the channels 704 formed in the surface that contacts one of the panels 12. The collar/nut 79 may have an annular recess and a second anode insert within the annular recess, as discussed above. The collar/nut 79 may also have the channels 704 formed between the faces 712 that contact one of the panels 12.

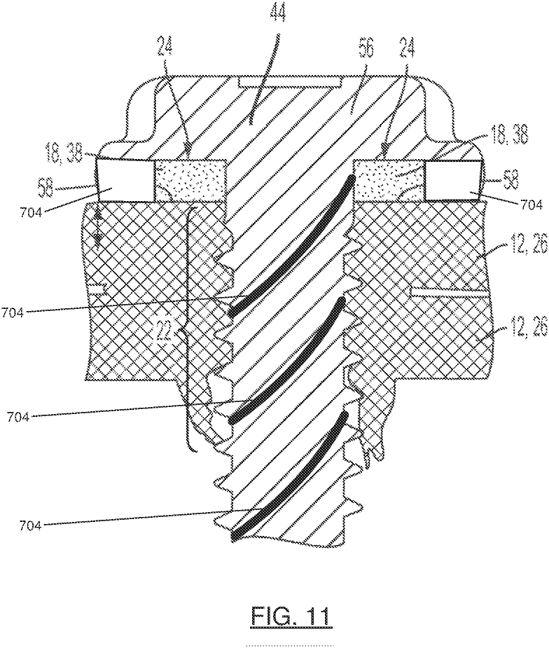

While the example of the channels 704 extending radially outwardly is provided, the present application is also applicable to the channels 704 extending axially along the shaft portion 22, such as in the example of FIG. 10, and helically (e.g., single or double helically), such as in the example of FIG. 11.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A fastening assembly comprising:
a panel defining an aperture;
a fastener having a cap and a shaft extending from the cap, the shaft being disposed through the aperture, the fastener having a first corrosion rate, and the fastener including:
a recess formed in the cap and extending at least partially around the shaft;
face surfaces that are planar and that are to directly contact the panel; and
recessed channels that are disposed between the face surfaces, respectively, that are recessed relative to the face surfaces, and that extend from a radially outer edge of the cap to the recess; and
an anode insert disposed in the recess and having a second corrosion rate that is faster than the first corrosion rate.

2. The fastening assembly as defined in claim 1 wherein the panel includes carbon fiber.

3. The fastening assembly of claim 1 wherein the fastener is made of steel.

4. The fastening assembly of claim 1 wherein the anode insert is made of aluminum.

5. The fastening assembly of claim 1 wherein the recess is an annular recess that encircles the shaft.

6. The fastening assembly of claim 1 wherein the panel has a third corrosion rate, and the second corrosion rate is faster than the third corrosion rate.

7. The fastening assembly of claim 1 wherein the recessed channels extend radially outwardly from the recess to the radially outer edge of the cap.

8. The fastening assembly of claim 1 further comprising a retention component configured to engage an engagement feature of the fastener.

9. The fastening assembly of claim 8 wherein the fastener is a mandrel and the retention component is a sleeve.

10. The fastening assembly of claim 9 wherein the sleeve includes a recess and a second anode insert disposed in the recess.

11. The fastening assembly of claim 8 wherein the fastener is a bolt having a threaded shaft and the retention component is a nut threaded onto the threaded shaft.

12. The fastening assembly of claim 11 wherein the nut includes a recess and a second anode insert disposed in the recess.

13. The fastening assembly as defined in claim 1 wherein the fastener is one of a rivet and a flow screw.

14. The fastening assembly of claim 1 wherein the fastener has a higher electrode potential than the anode insert.

15. The fastening assembly of claim 1 wherein a depth of the recessed channels is between 0.5 millimeters and one-half of a thickness of the cap.

16. The fastening assembly of claim 1 wherein the recessed channels are half cylindrical.

17. The fastening assembly of claim 1 wherein the recessed channels are disposed equidistantly from each other radially around the shaft.

18. A truck comprising:
a truck bed;
a truck bed liner including the panel; and
the fastening assembly of claim 1 fastening the truck bed liner to the truck bed.

19. A fastening assembly comprising:
a fastener having a cap and a shaft extending from the cap, the fastener having a first corrosion rate, and the fastener including:
a recess formed in the cap and extending at least partially around the shaft;
face surfaces that are planar; and
recessed channels that are disposed between the face surfaces, respectively, that are recessed relative to the face surfaces, and that extend from a radially outer edge of the cap to the recess; and
an anode insert disposed in the recess and having a second corrosion rate that is faster than the first corrosion rate.

20. A fastening assembly comprising:
a fastener having a cap and a shaft extending from the cap, the fastener having a first electrode potential, and the fastener including:
one or more recesses formed in the fastener;
outer surfaces; and
recessed channels that are recessed relative to the outer surfaces, and that extend from an outer edge of the fastener to the one or more recesses; and
one or more anode inserts disposed in the one or more recesses and having a second electrode potential that is less than the first electrode potential.
